(19) United States
(12) Patent Application Publication
(10) Pub. No.: US 2026/0086855 A1
(43) Pub. Date: Mar. 26, 2026

(54) Systems and Methods for Providing Distributed Computation Among a Plurality of Industrial Edge Devices

(71) Applicant: Clearpath Robotics Inc., Kitchener (CA)

(72) Inventor: Ryan Christopher GARIEPY, Kitchener (CA)

(21) Appl. No.: 18/895,955

(22) Filed: Sep. 25, 2024

(51) Int. Cl. G06F 9/50

(52) U.S. Cl. CPC G06F 9/5027

(57) ABSTRACT

Systems and methods for providing distributed computation among a plurality of industrial edge devices are provided. A method includes operating a virtual orchestrator in communication with the plurality of industrial edge devices to: receive one or more computational tasks; monitor a current computational capacity at the plurality of industrial edge devices to predict availability of computational capacity at each industrial edge device; project a future computational capacity at the plurality of industrial edge devices; identify available computational capacity for the one or more computational tasks based on the current computational capacity and the future computational capacity; for each computational task, determine a network bandwidth requirement for completing the computational task at one or more industrial edge devices; and allocate the one or more computational tasks among the industrial edge devices according to the available computational capacity and a network bandwidth efficiency based on the determined network bandwidth requirement.

### TECHNICAL FIELD

The described embodiments relate to industrial edge devices, and in particular, to systems and methods for providing distributed computation among a plurality of industrial edge devices.

### BACKGROUND

The following paragraphs are not an admission that anything discussed in them is prior art or part of the knowledge of persons skilled in the art.

The introduction of automated and autonomous systems in the performance of industrial and manufacturing processes has the potential to provide overall increases in productivity. However, the new technology of automated and autonomous systems may also introduce new problems in the performance of the industrial or manufacturing processes. As automated and autonomous systems become more complex and include more subsystems, components, and software, there is an associated increase in the amount of industrial data that needs to be processed and in the computational complexity of the data processing operations. For example, the growing autonomy of factory software can produce an associated increase in the quantity and dimensionality of optimization problems, and in the computational cost of training and inference in various neural networks. Edge computation enabled by industrial edge devices may be used to meet the growing computational capacity requirements in many industrial applications. In addition, the processing of this industrial data brings with it security, privacy, and confidentiality risks which are highly based on where it is processed and how it is transmitted.

### SUMMARY

In a first aspect, there is a method for providing distributed computation among a plurality of industrial edge devices. The method includes operating a virtual orchestrator in communication with the plurality of industrial edge devices to: receive one or more computational tasks; monitor a current computational capacity at the plurality of industrial edge devices to predict availability of computational capacity at each industrial edge device; project a future computational capacity at the plurality of industrial edge devices; identify available computational capacity for the one or more computational tasks based on the current computational capacity and the future computational capacity; for each computational task, determine a network bandwidth requirement for completing the computational task at one or more industrial edge devices of the plurality of industrial edge devices; and allocate the one or more computational tasks among the industrial edge devices according to the available computational capacity and a network bandwidth efficiency based on the network bandwidth requirement determined for each computational task.

According to some embodiments, the method further includes operating the virtual orchestrator to allocate at least one computational task of the one or more computational tasks to two or more of the plurality of industrial edge devices to provide redundancy.

According to some embodiments, the method further includes pausing an industrial task being performed at one of the plurality of industrial edge devices to make computational capacity available for completing an allocated computational task.

According to some embodiments, the network bandwidth requirement for completing the computational task is based on a data size, a data source location, and/or a data destination location.

According to some embodiments, the future computational capacity at each of the plurality of industrial edge devices is based on i) one or more allocated industrial tasks and ii) one or more task parameters associated with the allocated industrial tasks.

According to some embodiments, projecting the future computational capacity includes at least one of the plurality of industrial edge devices submitting a bid, to the virtual orchestrator, for completion of at least one of the one or more computational tasks, the bid including projected available computational capacity and/or a projected completion time.

According to some embodiments, the bid is based on a tolerance parameter indicating ability to pause an industrial task being performed to make computational capacity available for completing computational task subject to the bid.

According to some embodiments, at least one of the computational tasks is received from one or more devices connected to the virtual orchestrator within an internal industrial network environment.

According to some embodiments, at least one of the computational tasks is received from one or more devices connected to the virtual orchestrator via an external network.

In a second aspect, there is a system for providing distributed computation among a plurality of industrial edge devices. The system includes a virtual orchestrator in communication with the plurality of industrial edge devices. The virtual orchestrator is configured to: receive one or more computational tasks; monitor a current computational capacity at the plurality of industrial edge devices to predict availability of computational capacity at each industrial edge device; project a future computational capacity at the plurality of industrial edge devices; identify available computational capacity for the one or more computational tasks based on the current computational capacity and the future computational capacity; for each computational task, determine a network bandwidth requirement for completing the computational task at one or more industrial edge devices of the plurality of industrial edge devices; and allocate the one or more computational tasks among the industrial edge devices according to the available computational capacity and a network bandwidth efficiency based on the network bandwidth requirement determined for each computational task.

According to some embodiments, the virtual orchestrator is further configured to allocate at least one computational task of the one or more computational tasks to two or more of the plurality of industrial edge devices to provide redundancy.

According to some embodiments, each of the plurality of industrial edge devices includes a tolerance parameter indicating that an industrial task being performed can be paused to make computational capacity available for completing an allocated computational task.

According to some embodiments, the network bandwidth requirement for completing the computational task is based on a data size, a data source location, and/or a data destination location.

According to some embodiments, the future computational capacity at each of the plurality of industrial edge devices is based on i) one or more allocated industrial tasks and ii) one or more task parameters associated with the allocated industrial tasks.

According to some embodiments, the future computational capacity projection is based on a bid, submitted by at least one of the plurality of industrial edge devices, for completion of at least one of the one or more computational tasks, the bid including projected available computational capacity and/or a projected completion time.

According to some embodiments, the bid is based on a tolerance parameter indicating ability to pause an industrial task being performed to make computational capacity available for completing computational task subject to the bid.

According to some embodiments, the virtual orchestrator is configured to receive at least one of computational tasks from one or more devices connected to the virtual orchestrator within an internal industrial network environment.

According to some embodiments, the virtual orchestrator is configured to receive at least one of the computational tasks from one or more devices connected to the virtual orchestrator via an external network.

### BRIEF DESCRIPTION OF THE DRAWINGS

Several embodiments will now be described in detail with reference to the drawings, in which:

FIG. 1 is a block diagram of a system including multiple industrial edge devices, according to at least one embodiment;

FIG. 2 is a block diagram of a system including a virtual orchestrator to provide distributed computation among a plurality of industrial edge devices, according to at least one embodiment;

FIG. 3 is a block diagram of a self-driving industrial vehicle that is an example embodiment of the industrial edge devices shown in FIG. 2;

FIG. 4 is a schematic diagram of the self-driving industrial vehicle of FIG. 3, according to at least one embodiment;

FIG. 5 is a functional block diagram of the industrial edge devices of FIG. 3, according to at least one embodiment; and FIG. 6 is a flow diagram of a method for providing distributed computation among a plurality of industrial edge devices, according to at least one embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112, 112, and 112c). All elements with a common base number may be referred to collectively or generically using the base number without a suffix (e.g., 112).

### DETAILED DESCRIPTION

The total computational capacity provided by industrial edge devices will continue to grow rapidly as the total number of industrial edge devices and the computational capacity of each industrial edge device both increase. For example, it is now feasible to deploy teraflops of floating point computation and gigabits of connectivity on each industrial edge device.

The growing computational capacity provided by industrial edge devices can provide opportunities for distributed computation. An industrial edge device may utilize all of its computational capacity while performing compute-intensive tasks such as machine vision or high-frequency multi-axis control. However, there may be periods where the computational capacity at an industrial edge device is not fully utilized. The unutilized/excess computational capacity may be available for performing external computational tasks. As the total computational capacity provided by industrial edge devices increases, the total excess computational capacity is also likely to rise.

The disclosed systems and methods can provide distributed computation among a plurality of industrial edge devices to utilize the excess computational capacity. The disclosed systems and methods can improve utilization efficiency of computational capacity by allocating one or more external computational tasks to industrial edge devices to utilize the available excess computational capacity.

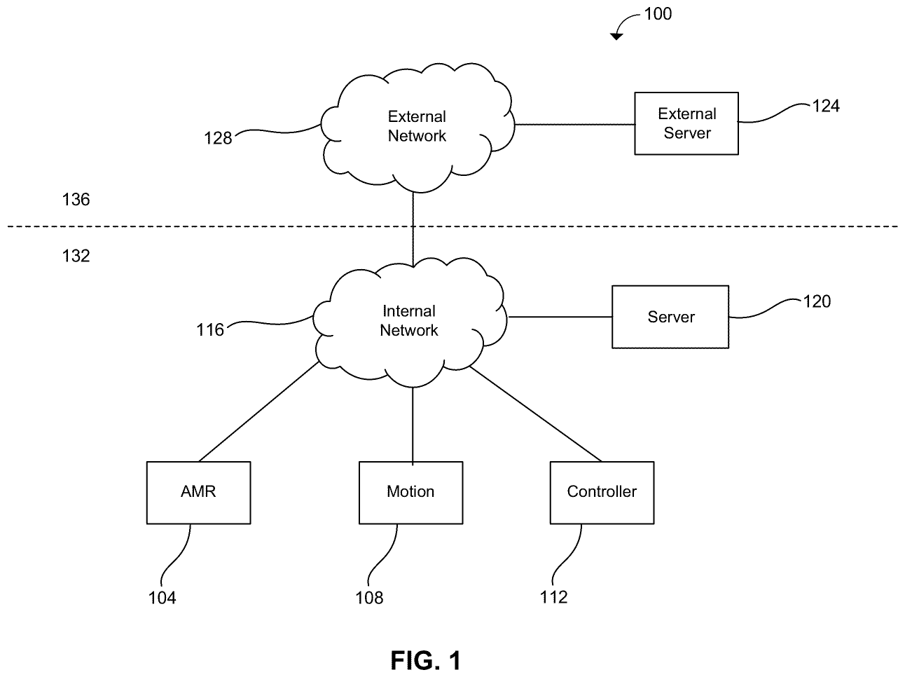

Many industrial applications may utilize a combination of industrial edge devices and local servers to provide the required computational capacity for various industrial and manufacturing processes. Referring to FIG. 1, there is shown a system 100 that includes multiple industrial edge devices in an industrial network environment 132. System 100 may include any suitable industrial edge devices. In the illustrated example, the industrial edge devices of system 100 include one or more autonomous mobile robots (AMRs) 104, one or more motion control devices 108, and one or more controllers 112.

Each industrial edge device (e.g., devices 104, 108, 112) may communicate with other components of system 100 using internal network 116. The industrial edge devices may communicate with internal network 116 using known telecommunications protocols and methods. For example, each industrial edge device may be equipped with a wireless communication interface to enable wireless communications within a LAN according to a WiFi protocol (e.g. IEEE 802.11 protocol or similar), or via a WWAN according to a 3G/4G protocol.

System 100 may include one or more internal servers 120 to provide additional computational capacity for system 100. Internal server 120 may be connected to the industrial edge devices via internal network 116.

The disclosed systems and methods may reduce/eliminate the local server requirements (e.g., internal servers 120) by improving the utilization efficiency of the computational capacity available at the industrial edge devices (e.g., devices 104, 108, 112). This can /duce/ eliminate the infrastructure requirements (e.g., space, power, cooling, etc.) and/or maintenance costs associated with the local servers. Further, the disclosed systems and methods may improve system resilience by distributing computational tasks among multiple industrial edge devices and eliminate any single point of failures associated with the local servers. Additionally, the disclosed systems and methods may reduce system latency by allocating computational tasks to industrial edge devices that are local to points of data generation and/or data utilization.

Furthermore, many industrial applications may utilize off-premise servers to provide the total required computational capacity for various industrial and manufacturing processes. In the illustrated example embodiment, system 100 may include one or more external servers 124, located in an external network environment 136, to provide additional computational capacity for system 100. External servers 124 may be connected to the industrial edge devices via an external network 128.

The disclosed systems and methods may reduce/eliminate the off-premise server requirements by improving the utilization efficiency of the computational capacity available at the industrial edge devices (e.g., devices 104, 108, 112). This can enable improved data security and/or privacy by removing risks/vulnerabilities associated with the off-premise servers and/or external network connections. Further, the disclosed systems and methods may reduce/eliminate the costs associated with the off-premise servers (e.g., external servers 124). Additionally, the disclosed systems and methods may reduce system latency by avoiding delays associated with utilizing external networks (e.g., external network 128) to access the off-premise servers.

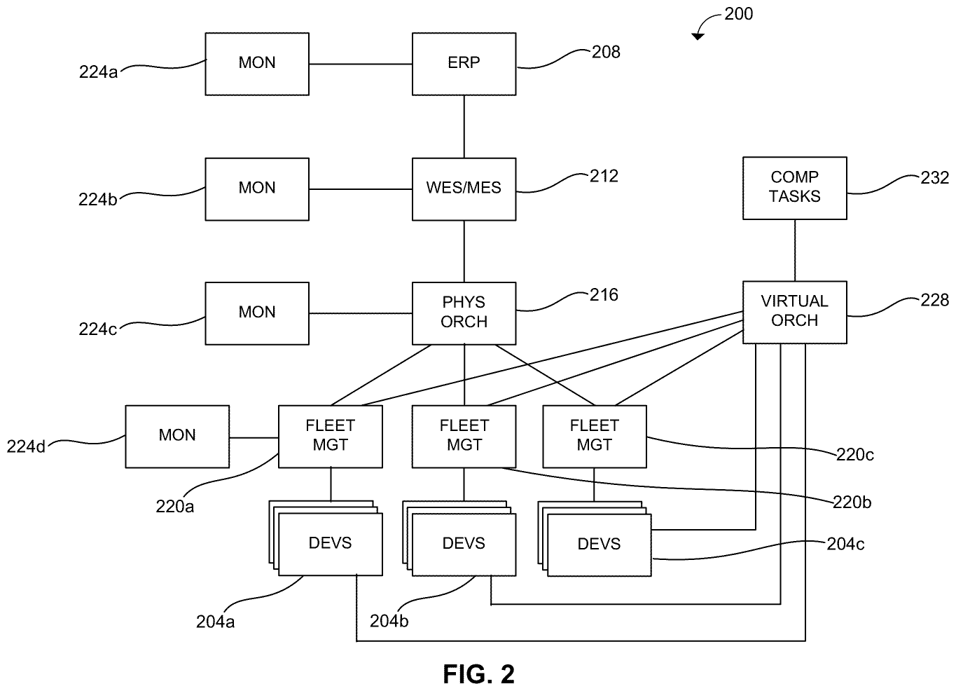

Referring to FIG. 2, there is shown an industrial system 200 that includes one or more industrial edge devices 204. Industrial edge devices 204 may include any suitable industrial edge devices. For example, industrial edge devices 204 may include mobile robots (e.g., self-driving industrial vehicles, drones, humanoids, mobile manipulators), fixed robots, motion control devices, factory controllers (e.g., programmable logic controllers (PLCs) running on commodity hardware, also referred to as soft PLCs), mobile sensing devices (e.g., devices for manual forklift tracking/dispatching equipment), fixed sensing devices (e.g., smart cameras), and/or worker devices (e.g., barcode scanners, head mounted displays).

Industrial system 200 may further include enterprise resource planning (ERP) 208, manufacturing execution system (MES)/warehouse execution system (WES) 212, a physical orchestrator 216, one or more fleet management systems 220, one or more monitoring devices 224, and a virtual orchestrator 228.

Physical orchestrator 216 may include any suitable combination of software and/or hardware device that allocates one or more industrial tasks for execution to industrial edge devices 204. For example, physical orchestrator 216 may include a processor and a memory that stores computer programs that are executable by the processor to perform the functions provided by physical orchestrator 216. Physical orchestrator 216 may further include a communication interface to enable network communication with other components of system 200.

The industrial tasks may be any tasks associated with industrial/manufacturing processes. Different industrial tasks may be assigned to different industrial edge devices based on the type of task and the capabilities of the industrial edge device. The industrial tasks allocated by physical orchestrator 216 may be received from WES/MES 212. In some embodiments, physical orchestrator 216 may generate the industrial tasks, for example, based on inputs received from WES/MES 212.

Industrial edge devices 204 may be organized into groups or fleets. Each fleet may have an associated fleet-management system 220. For example, fleet 204a of industrial edge devices may have associated fleet-management system 220a. Fleet management systems 220 may receive one or more industrial tasks from physical orchestrator 216 and assign the received tasks to the industrial edge devices 204 of that fleet. Each fleet-management system 220 may include a processor, a memory, and a communication interface to enable network communication with other components of system 200. Fleet-management system 220 may use the memory to store computer programs that are executable by the processor to perform the functions provided by fleet management system 220. In some embodiments, fleet-management system 220 may generate the industrial tasks for industrial edge devices 204.

Monitoring devices 224 may be any suitable devices. For example, monitoring devices 224 may be desktop computer terminals, laptop computers, mobile devices such as mobile phone, smart phone, tablets, and smart watches, display-walls and display-wall controllers, virtual and augmented reality displays, and other similar devices. Each monitoring device 224 may include a processor and a memory. Each monitoring device 224 may further include a communications interface to enable network communication with other components of system 200. The communications interfaces may be used for wired and/or wireless communications.

The positions of the components 204, 208, 212, 216, 220, 224, 228 and 232 of system 200 are shown for illustrative purposes and are not limited to the positions shown. Other configurations of the components 204, 208, 212, 216, 220, 224, 228 and 232 are possible.

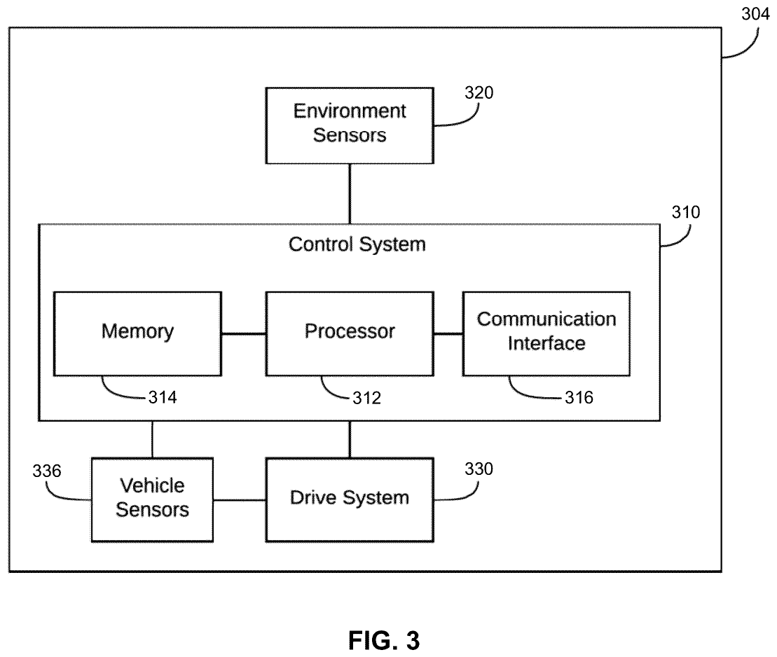

In some embodiments, one or more industrial edge devices 204 may be self-driving industrial vehicles. Referring to FIG. 3, there is shown a block diagram of a self-driving industrial vehicle 304, according to at least one embodiment. The self-driving industrial vehicle 304 generally includes a control system 310, at least one environment sensor 320, a drive system 330, and at least one vehicle sensor 336.

The control system 310 can include a processor 312, memory 314, and a communication interface 316. The control system 310 enables the self-driving industrial vehicle 304 to operate automatically and/or autonomously. The control system 310 can store an electronic map that represents the environment of the self-driving industrial vehicle 304, such as a facility, in the memory 314.

According to some embodiments, the communication interface 316 can be a wireless transceiver for communicating with a wireless communications network (e.g. using an IEEE 802.11 protocol, a 3G/4G protocol or similar).

One or more environment sensors 320 may be included in the self-driving industrial vehicle 304 to obtain data about the environment of the self-driving industrial vehicle 304. These environment sensors 320 can be distinguished from other sensors 336. For example, according to some embodiments, an environment sensor 320 may be a LiDAR device (or other optical, sonar, or radar-based range-finding devices known in the art). An environment sensor 320 may comprise optical sensors, such as video cameras and systems (e.g., stereo vision, structured light). Other examples of environment sensors include humidity sensors for measuring the ambient humidity in the facility, thermal sensors for measuring the ambient temperature in the facility, and microphones for detecting sounds.

According to some embodiments, the self-driving industrial vehicle 304 may receive a mission from a fleet-management system 220 or other external computer system in communication with the self-driving industrial vehicle 304 (e.g. in communication via the communication interface 316). In this case, the mission contains one or more waypoints or destination locations. Based on the waypoint or destination location contained in the mission, the self-driving industrial vehicle 304, based on the control system 310, can autonomously navigate to the waypoint or destination location without receiving any other instructions from an external system. For example, the control system 310, along with the sensors 320, enable the self-driving industrial vehicle 304 to navigate without any additional navigational aids such as navigational targets, magnetic strips, or paint/tape traces installed in the environment in order to guide the self-driving industrial vehicle 304.

For example, the control system 310 may plan a path for the self-driving industrial vehicle 304 based on a destination location and the location of the self-driving industrial vehicle 304. Based on the planned path, the control system 310 may control the drive system 330 to direct the self-driving industrial vehicle 304 along the planned path. As the self-driving industrial vehicle 304 is driven along the planned path, the environmental sensors 320 may update the control system 310 with new images of the environment of the self-driving industrial vehicle 304, thereby tracking the progress of the self-driving industrial vehicle 304 along the planned path and updating the location of the self-driving industrial vehicle 304.

Since the control system 310 receives updated images of the environment of the self-driving industrial vehicle 304, and since the control system 310 is able to autonomously plan the self-driving industrial vehicle's path and control the drive system 330, the control system 310 is able to determine when there is an obstacle in the self-driving industrial vehicle's path, plan a new path around the obstacle, and then drive the self-driving industrial vehicle 304 around the obstacle according to the new path.

The self-driving industrial vehicle 304 may also comprise one or more vehicle sensors 336. These vehicle sensors generally measure and monitor the state of the vehicle 304 itself, as compared to the environment sensors 320, which sense the vehicle's environment. The vehicle sensors 336 may be associated with particular components of the vehicle 304. For example, the vehicle sensors 336 may be current and/or voltage sensors for measuring the current and/or voltage of a particular electrical component, or for determining an approximate state of battery charge. The vehicle sensors 336 may be encoders for measuring the displacement, velocity, and/or acceleration (e.g. angular displacement, angular velocity, angular acceleration) of mechanical components such as motors, wheels, and shafts. The vehicle sensors 336 may be thermal sensors for measuring heat, for example, the heat of a motor or brake. The vehicle sensors 336 may be inertial measurement units for measuring motion of the body of the vehicle 304 (e.g. the vehicle sensors 336 may comprising accelerometers, gyroscopes, etc.). The vehicle sensors 336 may be water ingress sensors for detecting water within the body of the vehicle 304.

According to some embodiments, vehicle state information may not be limited to only the information derived from the vehicle sensors 336. For example, vehicle state information may also pertain to the mission that the vehicle is executing, the status of the mission, and other operational parameters known to the control system 310 independent of input from the vehicle sensors 336.

For simplicity and clarity of illustration, the example shown in FIG. 3 shows a single block labelled “environment sensors” 320 and a single block labelled “vehicle sensors”336, each in communication with the control system 310. According to some embodiments, there may be any number of environment sensors 320 and/or vehicle sensors 336, which may or may not all be in communication with the drive system 330, depending on the nature of the particular environment sensors 320 and vehicle sensors 336. In this example, the vehicle sensors 336 are shown in communication with the drive system 330 in order to measure characteristics of the drive system 330, for example, motor speed, motor temperature, etc.

The vehicle environment sensors 320 are generally in communication with the control system 310 so that the control system 310 can receive the measurements from the environment sensors, for example, in order to determine or provide environment state information. Similarly, the vehicle sensors 336 are generally in communication with the control system 310 so that the control system 310 can receive the measurements from the vehicle sensors, for example, in order to determine or provide vehicle state information.

The positions of the components 310, 312, 314, 316, 320, 330, and 336 of the self-driving industrial vehicle 304 are shown for illustrative purposes and are not limited to the positions shown. Other configurations of the components 310, 312, 314, 316, 320, 330, and 336 are possible.

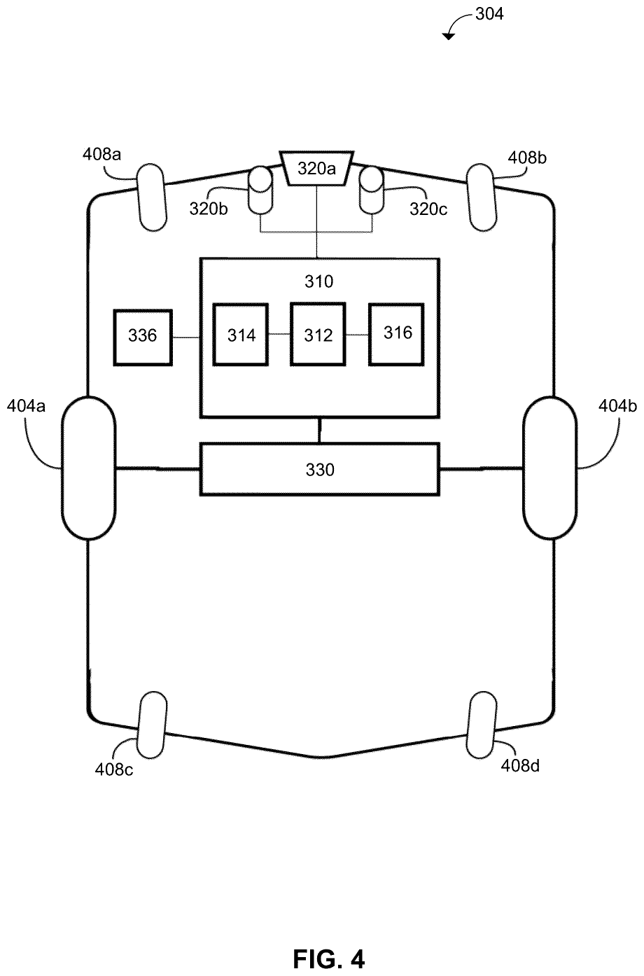

Referring to FIG. 4, there is shown a schematic diagram of a self-driving industrial vehicle 304, according to at least one embodiment. The drive system 330 includes a motor and/or brakes connected to drive wheels 404a and 404b for driving the self-driving industrial vehicle 304. According to some embodiments, the motor may be an electric motor, a combustion engine, or a combination/hybrid thereof. According to some embodiments, there may be one motor per drive wheel, for example, one for drive wheel 404a and one for drive wheel 404b. Depending on the particular embodiment, the drive system 330 may also include control interfaces that can be used for controlling the drive system 330. For example, the drive system 330 may be controlled to drive the drive wheel 404a at a different speed than the drive wheel 404b in order to turn the self-driving industrial vehicle 304. Different embodiments may use different numbers of drive wheels, such as two, three, four, etc.

According to some embodiments, additional wheels 334 may be included (e.g., wheels 408a, 408b, 408c, and 408d shown in FIG. 4). Any or all of the additional wheels 408 may be wheels that are capable of allowing the self-driving industrial vehicle 304 to turn, such as castors, omni-directional wheels, and mecanum wheels.

According to some embodiments, the environment sensors 320 (e.g., the sensors 320a, 320b, and 320c shown in FIG. 4) may be optical sensors arranged in a manner to provide three-dimensional (e.g. binocular or RGB-D) imaging.

The vehicle 304 may also include one or more vehicle sensors 336, as previously described with reference to FIG. 3.

The positions of the components 310, 312, 314, 316, 320, 330, 336, 404 and 408 of self-driving industrial vehicle 304 are shown for illustrative purposes and are not limited to the shown positions. Other configurations of the components 310, 312, 314, 316, 320, 330, 336, 404 and 408 are possible.

Referring back to FIG. 2, virtual orchestrator 228 may include any suitable combination of software and/or hardware device that allocates one or more computational tasks 232 for execution to industrial edge devices 204. For example, virtual orchestrator 228 may include a processor and a memory that stores computer programs that are executable by the processor to perform the functions provided by virtual orchestrator 228. Virtual orchestrator 228 may further include a communication interface to enable network communication with other components of system 200.

Computational tasks 232 may include any suitable computational tasks. For example, computational tasks 232 may include computational tasks associated with various systems and processes providing industrial automation/autonomy. Computational tasks 232 may be received from one or more of ERP 208, WES/MES 212, physical orchestrator 216, fleet management systems 220, and industrial edge devices 204. Virtual orchestrator 228 may reduce/eliminate server requirements (e.g., internal servers 120 and/or external servers 124 shown in FIG. 1) that would otherwise be needed to execute the computational tasks. In some embodiments, computational tasks 232 may be received from external servers/devices. For example, virtual orchestrator 228 may enable system 200 to utilize available computational capacity of industrial edge devices 204 to provide function as a service (FaaS) or platform as a service (SaaS) cloud computing services to external entities.

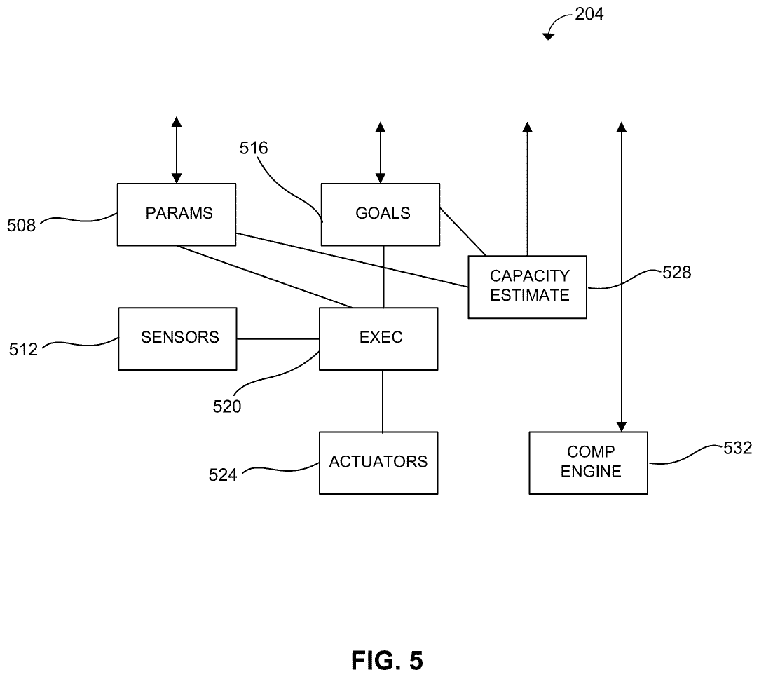

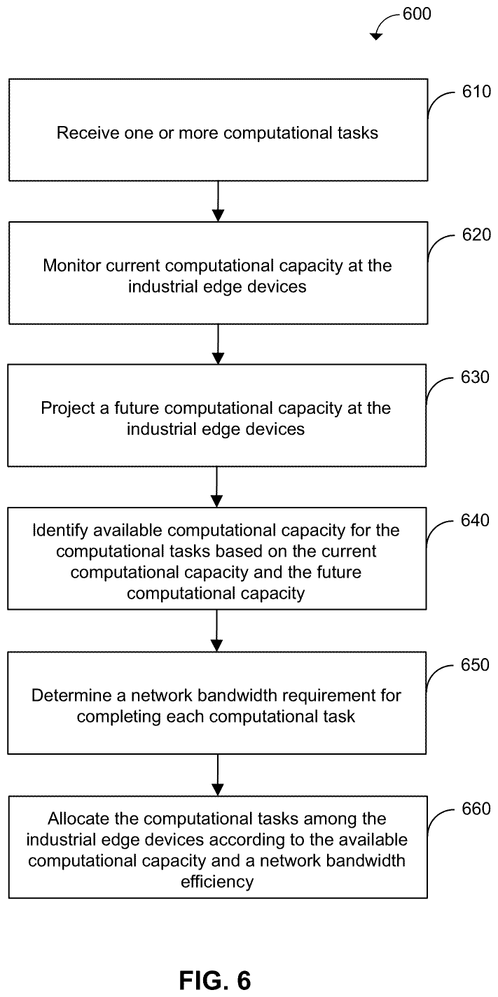

Referring to FIG. 5, there is shown a functional block diagram of an industrial edge device 204, according to at least one embodiment. Industrial edge device 204 includes an executive 520, one or more sensors 512, one or more actuators 524, computation engine 532, parameters 508, goals 516 and capacity estimate 528.

Executive 520 may control various executive functions of industrial edge device 204 to perform one or more industrial tasks using actuators 524. Goals 516 may include one or more industrial tasks assigned to industrial edge device 204. The industrial tasks may be assigned, for example, by physical orchestrator 216 or fleet management system 220 (shown in FIG. 2). Sensors 512 may generate sensor data that describes state information associated with industrial edge device 204. For example, sensors 512 may generate sensor data describing state information of industrial edge device 204 while performing an industrial task.

Computation engine 532 may include any suitable design to enable industrial edge device 204 to perform computations related to allocated industrial tasks. For example, computation engine 532 may include any suitable combination of one or more central processing units (CPUs), one or more graphic processing units (GPUs), and one or more memory/storage devices.

Parameters 508 may be associated with industrial edge device 204 and/or goals 516. For example, parameters 508 may include information describing total CPU capacity, total GPU capacity, and/or total memory/storage capacity at industrial edge device 204. In some embodiments, parameters 508 may include information describing amount of CPU capacity, GPU capacity, and/or memory/storage capacity required for performing a specific industrial task.

Optionally, parameters 508 may include information describing amount of CPU capacity, GPU capacity, and/or memory/storage capacity required for performing one or more industrial tasks at different execution levels. For example, the industrial edge device may be a sensor device and parameters 508 may include information describing amount of CPU, GPU and memory capacity required for processing sensor data captured at a rate that is half of the maximum data capture rate.

In some embodiments, parameters 508 may include one or more tolerance parameters indicating whether execution of any industrial tasks can be paused or performed at a lower execution level. The industrial task may be paused or performed at a lower execution level to reallocate computational capacity currently being used for that industrial task towards one or more computational tasks received from virtual orchestrator 228.

Each tolerance parameter may be associated with an industrial task capable of being performed by industrial edge device 204. Any suitable implementation may be used for the tolerance parameters. For example, the tolerance parameter may include a binary variable indicating whether that industrial task can be paused to make computational capacity available for performing one or more computational tasks allocated by virtual orchestrator 228 (shown in FIG. 2). An industrial task may include multiple task steps and the tolerance parameter may further indicate which of the multiple task steps can be paused.

As one example, the industrial edge device may be a self-driving industrial vehicle and the industrial task may be transfer of an object from a pick-up location to a drop-off location. The tolerance parameter may indicate that the task step of navigation towards the pick-up location may be paused to make additional computational capacity available. The tolerance parameter may further indicate that the tasks steps of picking up the object, carrying the object and dropping off the object may not be paused.

In some embodiments, the tolerance parameter may indicate a minimum execution level for that task/task step. For example, the minimum execution level may be defined as a percentage of a maximum execution level. Industrial edge device 204 may utilize sufficient computational resources to perform the task at the minimum execution level and utilize remaining computational capacity for performing one or more computational tasks allocated by the virtual orchestrator.

For example, a task step may include route determination for a self-driving vehicle to navigate to a destination location. The tolerance parameter may indicate that 60% of the computational capacity available at industrial edge device 204 may be utilized to perform the route determination task step at a minimum execution level and the remaining 40% of computational capacity may be utilized for performing one or more computational tasks allocated by the virtual orchestrator.

Capacity estimate 528 may include capacity estimate data related to current computational capacity available at industrial edge device 204. The capacity estimate data can indicate the amount of computational capacity (e.g., CPU, GPU, memory) being currently used at industrial edge device 204 and the computational capacity currently available at industrial edge device 204.

In some embodiments, capacity estimate 528 may include data related to a predicted/future availability of computational capacity at industrial edge device 204. The predicted availability of computational capacity may be based on goals 516 and parameters 508. For example, the predicted availability of computational capacity may be based on future industrial tasks to be performed and the computational capacity required for performing the future industrial tasks. In some embodiments, the predicted availability of computational capacity may be further based on tolerance parameters indicating whether the future industrial tasks can be paused/performed at lower execution levels.

Referring to FIG. 6, there is a flow diagram of a method 600 for providing distributed computation among a plurality of industrial edge devices. The industrial edge devices may be any suitable industrial edge devices. For example, the industrial edge devices may be devices 104, 108, 112, 204, and/or 304 shown in FIGS. 1 to 5 and concurrent reference is made herein below to components shown in FIGS. 1 to 5.

According to some embodiments, all or parts of method 600 may be executed by a virtual orchestrator (e.g., virtual orchestrator 228 shown in FIG. 2) that is in communication with the plurality of industrial edge devices. In some embodiments, method 600 may be executed by a combination of components (e.g., any suitable combination of virtual orchestrator 228, fleet management systems 220 and industrial edge devices 204).

In some embodiments, method 600 may be continuously executed to allocate any received computational tasks among the industrial edge devices. In other embodiments, method 600 may not be continuously executed. For example, method 600 may be executed in response to receiving a computational task to be allocated to an industrial edge device. As another example, method 600 may be executed in response to a command input. The command input may be a user input or an automatically generated input.

At 610, method 600 may include receiving one or more computational tasks. For example, virtual orchestrator 228 may receive the computational tasks from ERP 208, WES/MES 212, physical orchestrator 216, fleet management systems 220, and/or industrial edge devices 204. In some embodiments, virtual orchestrator 228 may receive the computational tasks from one or more external devices (e.g., via external network 128).

At 620, method 600 may include monitoring a current computational capacity at a plurality of industrial edge devices to predict availability of computational capacity at each industrial edge device. For example, each industrial edge device may include a capacity estimate 528 that monitors computational capacity, for example, related to CPU capacity, GPU capacity, and memory/storage capacity.

At 630, method 600 may include projecting a future computational capacity at the plurality of industrial edge devices. For example, capacity estimate 528 of each industrial edge device may generate capacity estimate data based on future industrial tasks to be performed at that industrial edge device and parameters indicating computational capacity requirements associated with the future industrial tasks. The parameters can include, for example, tolerance parameters indicating whether the future industrial tasks can be paused or performed at a lower execution level.

In some embodiments, capacity estimate 528 of each industrial edge device may provide the capacity estimate data to virtual orchestrator 228. Industrial edge devices 204 may provide the capacity estimate data directly to virtual orchestrator 228 or via an intermediary component (e.g., via fleet management systems 220). In some embodiments, physical orchestration layer 216 and/or fleet management system 220 may provide supplementary capacity estimate data to virtual orchestrator 228. The supplementary capacity estimate data may be related to industrial tasks not yet allocated to industrial edge devices 240. For example, the supplementary capacity estimate data may indicate to virtual orchestrator 228 that 40% of the industrial edge devices 240 will have computational capacity available, but may not identify the specific industrial edge devices with available computational capacity (because the industrial tasks are not yet allocated to specific industrial edge devices).

Virtual orchestrator 228 may project a future computational capacity at the plurality of industrial edge devices based on the received capacity estimate data. In some embodiments, each industrial edge devices may determine future computational capacity (based on the capacity estimate data) at that industrial edge device and provide the projected future computational capacity (directly or via an intermediary component) to virtual orchestrator 228.

In some embodiments, projecting the future computational capacity may include the industrial edge devices submitting bids for completion of a computational task. For example, virtual orchestrator 228 may transmit a bid request for completion of a computational task to one or more industrial edge devices. In response to the bid request, the industrial edge devices may submit bids for completion of the computational task. The submitted bids may include projected available computational capacity and/or a projected completion time for the computational task.

In some embodiments, virtual orchestrator 228 may transmit the bid request to all the industrial edge devices of the system. In other embodiments, virtual orchestrator 228 may first receive information indicating projected available computational capacity at the industrial edge devices. Virtual orchestrator 228 may select a subset of the industrial edge devices based on the projected available computational capacity meeting a threshold condition. Further, virtual orchestrator 228 may transmit the bid request to the selected subset of the industrial edge devices.

The future computational capacity may be projected for any suitable time period. In some embodiments, the projection time period may be in a 1-30 minute time range. In other embodiments, the projection time period may be longer than 30 minutes (e.g., 30 minutes-2 hours) or shorter than 1 minute (e.g., 30 seconds-1 minute). Longer time periods may enable greater utilization of future available computational capacity at the industrial edge devices, or longer running processes. Shorter time periods may reduce the computational resources consumed to generate the projections or increase the certainty of the projections. The projection time period may be based on a parameter stored at virtual orchestrator 228. In some embodiments, the projection time period may be based on an input received at virtual orchestrator 228.

In some embodiments, a confidence score may be generated for the projected future computational capacity. For example, virtual orchestrator 228 may generate a confidence score for the projected future computational capacity at each industrial edge device based on the duration of the projection time period and/or the probability level associated with future computational capacity requirement predictions at the industrial edge device.

At 640, method 600 may include identifying available computational capacity for the received computational tasks based on the current computational capacity and the future computational capacity. For example, virtual orchestrator 228 may identify the amount of available computational capacity at each industrial device and the associated availability times for the projected time period.

In some embodiments, virtual orchestrator 228 may additionally identify available computational capacity at one or more network servers (if present). The servers may include internal servers 120 (FIG. 1) or external servers 124 (FIG. 1). Virtual orchestrator 228 may identify the available computational capacity at the servers based on known server loading profiles (e.g., a fixed loading profile, or a known variable loading profile). In some embodiments, the servers may provide projected future available computational capacity to virtual orchestrator 228.

At 650, method 600 may include determining, for each computational task, a network bandwidth requirement for completing the computational task at one or more industrial edge devices of the plurality of industrial edge devices. In some embodiments, virtual orchestrator 228 may determine the network bandwidth requirement for completing the computational task based on a data size, a data source location, and/or a data destination location.

At 660, method 600 may include allocating the received computational tasks among the industrial edge devices according to the available computational capacity and a network bandwidth efficiency based on the network bandwidth requirement determined for each computational task.

For each computational task, virtual orchestrator 228 may determine a network bandwidth efficiency based on the network bandwidth requirement determined at 650. For example, the computational task may be related to processing sensor data captured by an industrial edge device including a sensor. The data size associated with the captured sensor data may be substantially larger compared with the data size after the captured sensor data is processed (e.g., a processed summary value of the captured sensor data). Virtual orchestrator 228 may associate a higher network bandwidth efficiency for completing the computational task related to processing the sensor data at the data source location itself (the industrial edge device including the sensor) compared with transmitting a large amount of captured sensor data to another industrial edge device for processing.

In some embodiments, determining the network bandwidth efficiency may include determining whether the determined network bandwidth requirement includes data communication over an external network. For example, virtual orchestrator 228 may associate a low network bandwidth efficiency for data communication over an external network. This may enable higher data security and privacy by prioritizing allocation of computational tasks to industrial edge devices and/or internal servers interconnected via an internal network.

For any given computational task, if multiple industrial edge devices have sufficient available computational capacity, virtual orchestrator 228 may allocate the computational task to the industrial edge device that maximizes the network bandwidth efficiency. In some embodiments, virtual orchestrator 228 may determine an availability score for each industrial edge device. The availability score may be based on one or more of an amount of available computational capacity, an availability time associated with the available computational capacity (e.g., how soon is the computation capacity available) and/or a confidence score associated with the projected future computational capacity. Virtual orchestrator 228 may allocate the computational task based on a weighted combination of the availability score and the network bandwidth efficiency.

In some embodiments, virtual orchestrator 228 may utilize one or more additional factors in allocating the computational tasks. For example, each received computational task may have an associated priority level. Virtual orchestrator 228 may not utilize the network bandwidth efficiency in allocating computational tasks with a high priority level. Virtual orchestrator 228 may allocate high priority level computational tasks to industrial edge devices having a higher confidence score associated with projected future computational capacity. In some embodiments, virtual orchestrator 228 may allocate high priority level computational tasks to multiple industrial edge devices to provide redundancy against any errors in projected future computational capacity at the industrial edge devices.

In some embodiments, after virtual orchestrator 228 allocates a computational task to a given industrial edge device, the industrial edge device may provide one or more task status updates to virtual orchestrator 228. The task status updates may indicate whether there are any changes in the actual available computational capacity (compared with the projected available computational capacity) and whether the changes (if any) will impact completion of the computational task. In some embodiments, the industrial edge device may pause or reduce the execution levels of one or more industrial tasks to compensate for the change in available computational capacity.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

As used herein, the term “media” generally means “one medium or more than one medium”.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers may be a server, network appliance, embedded device, computer expansion module, a personal computer, laptop, a wireless device or any other computing device capable of being configured to carry out the methods described herein.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims.

We claim:

1. A method for providing distributed computation among a plurality of industrial edge devices, the method comprising operating a virtual orchestrator in communication with the plurality of industrial edge devices to:
receive one or more computational tasks;
monitor a current computational capacity at the plurality of industrial edge devices to predict availability of computational capacity at each industrial edge device;
project a future computational capacity at the plurality of industrial edge devices;
identify available computational capacity for the one or more computational tasks based on the current computational capacity and the future computational capacity;
for each computational task, determine a network bandwidth requirement for completing the computational task at one or more industrial edge devices of the plurality of industrial edge devices; and
allocate the one or more computational tasks among the industrial edge devices according to the available computational capacity and a network bandwidth efficiency based on the network bandwidth requirement determined for each computational task.

2. The method of claim 1, further comprising operating the virtual orchestrator to allocate at least one computational task of the one or more computational tasks to two or more of the plurality of industrial edge devices to provide redundancy.

3. The method of claim 1, further comprising pausing an industrial task being performed at one of the plurality of industrial edge devices to make computational capacity available for completing an allocated computational task.

4. The method of claim 1, wherein the network bandwidth requirement for completing the computational task is based on a data size, a data source location, and/or a data destination location.

5. The method of claim 1, wherein the future computational capacity at each of the plurality of industrial edge devices is based on i) one or more allocated industrial tasks and ii) one or more task parameters associated with the allocated industrial tasks.

6. The method of claim 1, wherein projecting the future computational capacity includes at least one of the plurality of industrial edge devices submitting a bid, to the virtual orchestrator, for completion of at least one of the one or more computational tasks, the bid including projected available computational capacity and/or a projected completion time.

7. The method of claim 6, wherein the bid is based on a tolerance parameter indicating ability to pause an industrial task being performed to make computational capacity available for completing computational task subject to the bid.

8. The method of claim 1, wherein at least one of the computational tasks is received from one or more devices connected to the virtual orchestrator within an internal industrial network environment.

9. The method of claim 1, wherein at least one of the computational tasks is received from one or more devices connected to the virtual orchestrator via an external network.

10. A system for providing distributed computation among a plurality of industrial edge devices, the system comprising a virtual orchestrator in communication with the plurality of industrial edge devices, the virtual orchestrator being configured to:
receive one or more computational tasks;
monitor a current computational capacity at the plurality of industrial edge devices to predict availability of computational capacity at each industrial edge device;
project a future computational capacity at the plurality of industrial edge devices;
identify available computational capacity for the one or more computational tasks based on the current computational capacity and the future computational capacity;
for each computational task, determine a network bandwidth requirement for completing the computational task at one or more industrial edge devices of the plurality of industrial edge devices; and
allocate the one or more computational tasks among the industrial edge devices according to the available computational capacity and a network bandwidth efficiency based on the network bandwidth requirement determined for each computational task.

11. The system of claim 10, wherein the virtual orchestrator is further configured to allocate at least one computational task of the one or more computational tasks to two or more of the plurality of industrial edge devices to provide redundancy.

12. The system of claim 10, wherein each of the plurality of industrial edge devices includes a tolerance parameter indicating that an industrial task being performed can be paused to make computational capacity available for completing an allocated computational task.

13. The system of claim 10, wherein the network bandwidth requirement for completing the computational task is based on a data size, a data source location, and/or a data destination location.

14. The system of claim 10, wherein the future computational capacity at each of the plurality of industrial edge devices is based on i) one or more allocated industrial tasks and ii) one or more task parameters associated with the allocated industrial tasks.

15. The system of claim 10, wherein the future computational capacity projection is based on a bid, submitted by at least one of the plurality of industrial edge devices, for completion of at least one of the one or more computational tasks, the bid including projected available computational capacity and/or a projected completion time.

16. The system of claim 15, wherein the bid is based on a tolerance parameter indicating ability to pause an industrial task being performed to make computational capacity available for completing computational task subject to the bid.

17. The system of claim 10, wherein the virtual orchestrator is configured to receive at least one of computational tasks from one or more devices connected to the virtual orchestrator within an internal industrial network environment.

18. The system of claim 10, wherein the virtual orchestrator is configured to receive at least one of the computational tasks from one or more devices connected to the virtual orchestrator via an external network.
